(19) United States
(12) Patent Application Publication
(10) Pub. No.: US 2004/0145309 A1
(43) Pub. Date: Jul. 29, 2004

(54) SEALING STRUCTURE AND METHOD OF MAKING THE SAME

(76) Inventors: Wei-Chih Lai, Kao-Hsiung Hsien (TW); Chih-Hung Su, Hsin-Chu City (TW)

Correspondence Address: NAIPO (NORTH AMERICA INTERNATIONAL PATENT OFFICE), P.O. BOX 506, MERRIFIELD, VA, 22116, US

(21) Appl. No.: 10/707,931

(22) Filed: Jan. 26, 2004

(30) Foreign Application Priority Data
Jan. 29, 2003 (TW) 092102076

(51) Int. Cl. H01J 9/26; H05B 33/02; H05B 33/00

(52) U.S. Cl. 313/512; 445/25

(57) ABSTRACT

A sealing structure and a method of making the same. The sealing structure is disposed on an organic light emitting display panel having a substrate and an organic light emitting display unit thereon. The sealing structure includes a passivation structure, a container, and a sealing agent. The passivation layer covers the substrate and the organic light emitting display unit and has a sealing slot extending through to the substrate surface. The seal agent is disposed in the bottom of the sealing slot for combining the container with the substrate surface in the bottom of the sealing slot.

### BACKGROUND OF INVENTION

1. Field of the Invention

The present invention relates to a sealing structure and a method of making the same, and more particularly, to a sealing structure in an organic light emitting display panel and a method of making the same.

2. Description of the Prior Art

The progress of science and technology has led to organic materials being well applied to all kinds of electrical devices. For example, organic light-emitting displays (OLEDs), which are formed by using organic materials, have the advantages of simpler structures, excellent operating temperature, high contrast, and a wide viewing angle, and have the beneficial characteristics of light-emitting diodes (LEDs), such as rectification and luminosity, so as to be used extensively in the field of display devices. Since the OLED uses luminous devices formed of organic materials to provide a light source, the OLED is very sensitive to the moisture. Once the organic light-emitting devices are exposed in the moisture, the cathode thereon may be oxidized and the interface of organic compounds may be peeled. This leads to dark spots being generated in the luminous devices, which deteriorates the brightness and the lifetime of the display devices. As a result, the package material used to package the electrical devices not only needs high anti-abrasiveness and thermal conductivity, but also requires low moisture permeability to prevent the organic materials from being exposed in the external environment effectively and to improve the lifetime of the electrical devices.

Please refer to FIG. 1, which is a schematic diagram of a conventional sealing structure in an organic light emitting display device. As shown in FIG. 1, the sealing structure 20 is disposed on an organic light emitting display panel 10. The organic light emitting display panel comprises a substrate 12 and an organic light emitting display unit 14 disposed on the substrate. Normally, the substrate 12 is a plastic substrate or a glass substrate. The organic light emitting display unit 14 is composed of a plurality of pixels and comprises an organic luminous layer and a driving circuit disposed on the surface of the substrate 12 for driving the pixels to display image.

The sealing layer 20 comprises a passivation layer 16 and a container 18. The passivation layer 16, which is typically composed of a multi-layer stacked structure, comprises at least a material with low moisture permeability, such as a silicon nitride layer, to avoid the moisture penetrating into the underneath organic light emitting display unit 14, causing deterioration of the display performance and shortening the lifetime of the electric devices. The container 18, which can be a metal container or a glass container, is combined to the passivation layer 16 with a sealing agent 22 to reinforce the protection ability toward the organic light emitting display panel 10. In addition, the closed room between the passivation layer 16 and the container 18 is often filled with a dry agent or dry nitrogen to avoid the moisture, oxygen, or other air from damaging the physical characteristic of the organic luminous layer, TFT devices, or other devices in the organic light emitting display unit 14 in advance, which may lead to deteriorating the display performance and shortening the lifetime of the electric devices.

Since both the passivation layer 16 and the container 18 have good water repelling ability, the seal condition or the adhesion among the passivation layer 16, the container 19, and the sealing agent 22 is very important for the package performance of the display panel. Generally speaking, the sealing agent 22 has different adhesion toward different materials. Therefore, in the packaging process, the composition of the sealing agent 22 is often adjusted according the attached materials to make the sealing agent 22 have an excellent adhesion to a specific material to reinforce the water repelling ability of the sealing structure 20.

However, while the sealing agent 22 adjusts the composition thereof to obtain a better adhesion for a specific mater, such as glass, its adhesion toward other materials is deteriorated at the same time. As a result, if lesser kinds of materials have to be bound by the sealing agent 22, the composition of the sealing agent 22 can be optimized more easily and a better sealing performance can be obtained thereby. When the package process of the organic light emitting display panel 10 is performed, the passivation layer 16 is needed for protecting the organic light emitting display unit 14. Therefore, the disadvantage is that the adhesion of the sealing agent 22 is weakened obviously due to the present of the passivation layer 16 at the same time. It causes the sealing agent to not perfectly seal on the passivation layer 16 and the container 18. Thus, the moisture easily penetrates along the gaps in the connection between the sealing agent 22 and adjacent devices so as to affect the lifetime of products and the display performance.

Therefore, it is important to develop a new sealing structure or method to improve the water repelling ability thereof so as to solve the aforementioned problem.

### SUMMARY OF INVENTION

It is therefore an object of the claimed invention to provide a sealing structure of an organic light emitting display panel and a method of making the same to solve the aforementioned problem of poor water repelling ability.

The claimed invention provides a sealing structure and a method of making the same. The sealing structure is disposed on an organic light emitting display panel comprising a substrate and an organic light emitting display unit positioned on the substrate. The sealing structure comprises a passivation layer, a container, and a sealing agent. The passivation layer covering the organic light emitting display unit and the substrate has a sealing slot extending through to the surface of the substrate enclosing the organic light emitting display unit for combining the container to the surface of the substrate in the bottom of the sealing slot.

The sealing structure of the claimed invention has a sealing slot extending through to the substrate surface so that the container can be directly combined to the substrate surface in the bottom of the sealing slot. Therefore, the attachment and the sealing performance among the container, the sealing agent, and the substrate can be improved effectively to avoid the moisture, oxygen, or other gases from damaging the organic materials in the organic light emitting display unit.

These and other objectives of the present invention will no doubt become obvious to those of ordinary skill in the art after having read the following detailed description of the preferred embodiment which is illustrated in the various figures and drawings.

### BRIEF DESCRIPTION OF DRAWINGS

FIG. 1 is a schematic diagram of a conventional sealing structure.

FIG. 2 is a schematic diagram of a sealing structure in a preferred embodiment of the present invention.

FIG. 3 to FIG. 6 are schematic diagrams of fabricating method of the sealing structure according to the present invention.

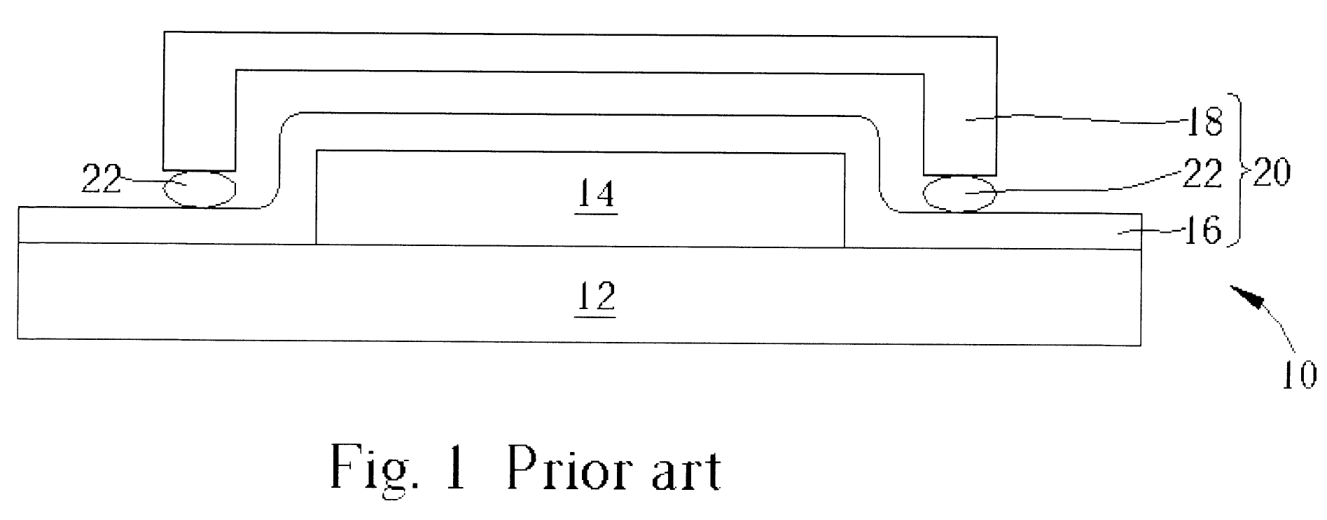

### DETAILED DESCRIPTION

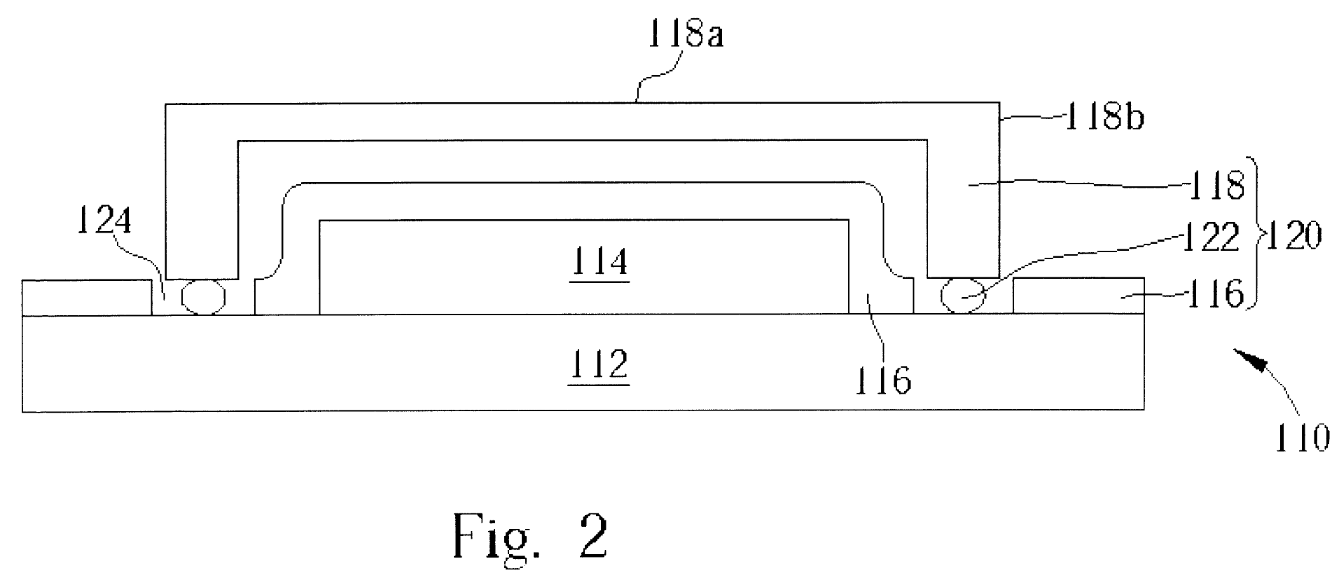

Please refer to FIG. 2. FIG. 2 is a schematic diagram of a sealing structure 120 in a preferred embodiment of the present invention. As shown in FIG. 2, the sealing structure 120 is disposed on an organic light emitting display panel 110 which comprises a substrate 112 and an organic light emitting display unit 114 positioned on the surface of the substrate 112. In the preferred embodiment of the present invention, the substrate 112 comprises a plastic substrate or a glass substrate. The organic light emitting display unit is formed of a plurality of pixels.

The sealing structure 120 comprises a passivation layer 116 and a container 118. In addition, a sealing agent is used to combine the container 116 with the substrate 112. As shown in FIG. 2, the passivation layer 116, which is covering the substrate 112 and the organic light emitting display unit 114, comprises a sealing slot 125 extending through to the surface of the substrate 112 and enclosing the organic light emitting display unit 114. The container 118 comprises a flat top plate 118a and an extruded side frame 118b surrounding the edge of the top plate 118a. The shape of the side frame 118b corresponds to that of the sealing slot 124 so that the side frame 118b of the container 118 can be combined to the substrate 112 surface in the bottom of the sealing slot 124 by using the sealing agent 122 coated on the bottom of the sealing slot 124.

In the preferred embodiment of the present invention, the passivation layer 116, which is a multi-layer stacked structure, comprises at least a water repelling layer and a buffer layer stacked in stagger. The water repelling layer is composed of a material with a low moisture permeability, such as a silicon nitride compounds or a silicon oxide compounds, for avoiding the moisture from penetrating into the beneath organic light emitting display unit 114. The buffer layer is used to reduce the stress of the water repelling layer and improve the attachment between the organic light emitting display unit 114 and the water repelling layer. In addition, the container 118 and the substrate 112 are both made of a glass material. Thus, the composition of the sealing agent 122 can be specifically adjusted for the glass material to reinforce the sealing ability toward the glass material. Furthermore, the sealing agent 122 can be formed of a curable material, such as a material of epoxy compounds, so that a curing process can be used to cure the sealing agent 122 and fix the container 118 onto the substrate 112.

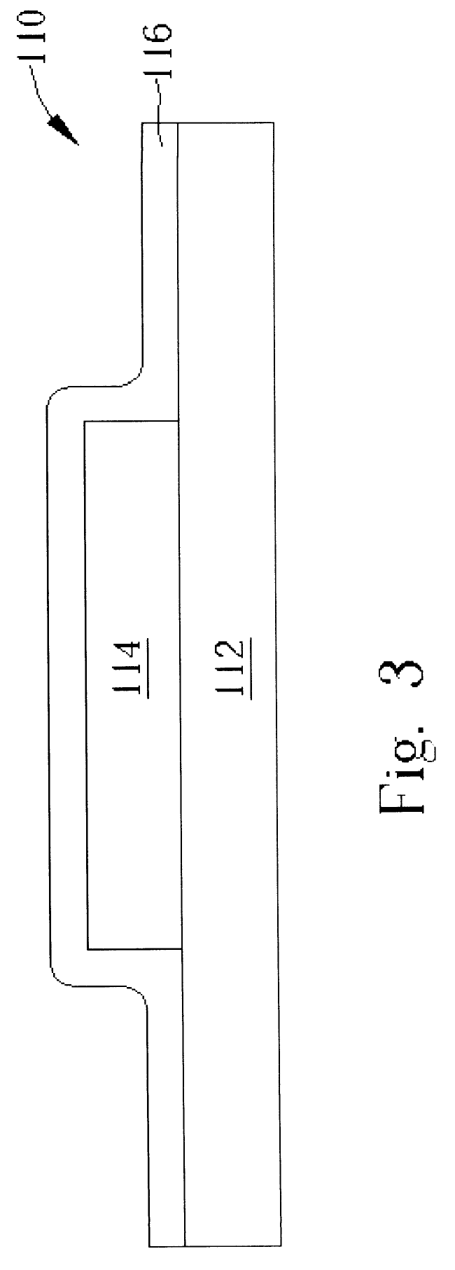

The fabricating method of the sealing structure 120 is detailed as follows. Please refer to FIG. 3 to FIG. 6, which are schematic diagrams of the fabricating method of the sealing structure 120 according the present invention. As shown in FIG. 3, the organic light emitting display unit 114 is first formed on the substrate 112. The passivation layer 116 is then formed to cover the organic light emitting display unit 114 and the substrate 112 to avoid the organic light emitting display unit 114 from being exposed in the external atmosphere.

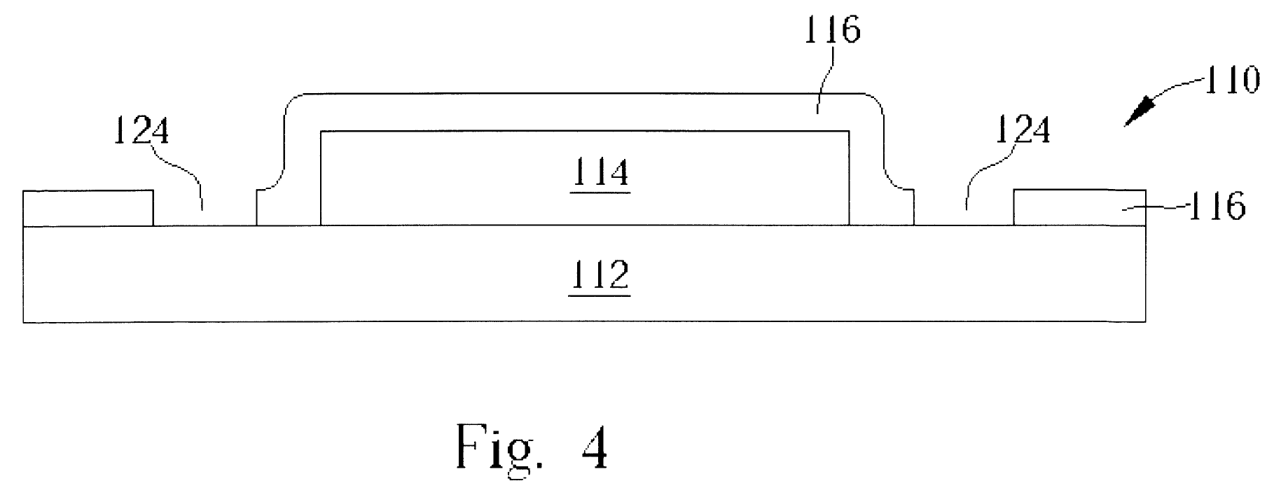

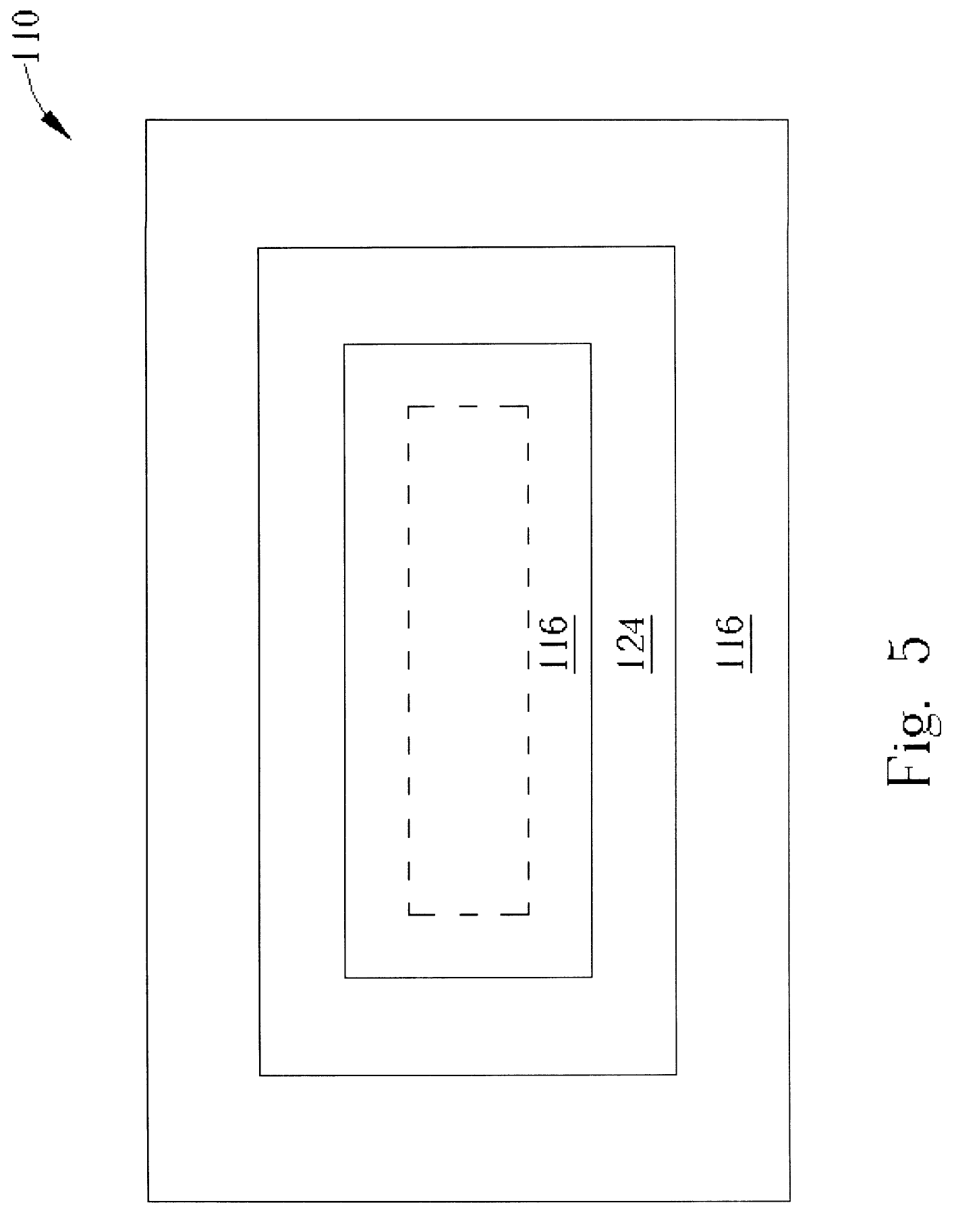

As shown in FIG. 4, a photolithography process is performed to form a patterned photoresist layer (not shown) on the surface of the passivation layer 116 to define a sealing region. After that, an etching process is performed to etch the passivation layer 116 by using the patterned photoresist layer as a hard mask and form the sealing slot 124 extended through to the surface of the substrate 112. As shown in FIG. 5, the sealing slot 124 encloses the organic light emitting display unit 114, which is illustrated as a dotted block, for performing the following sealing process.

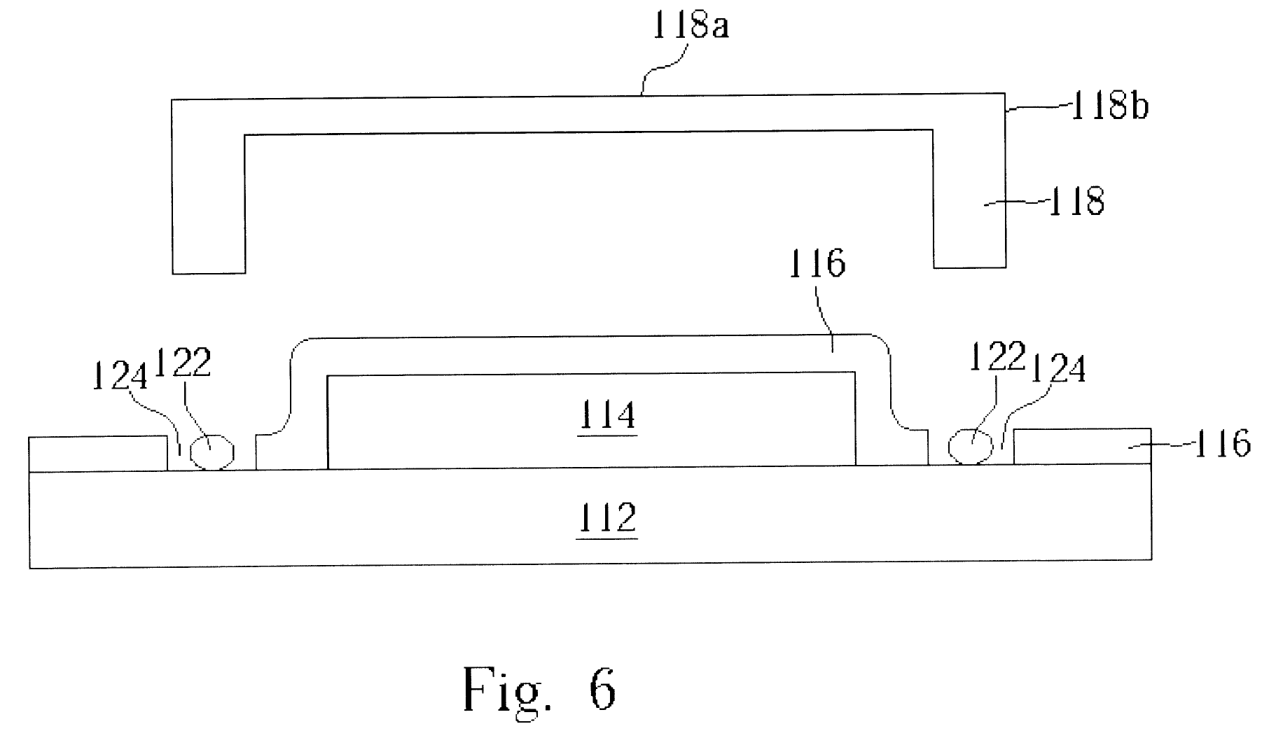

As shown in FIG. 6, the sealing agent 122 is then coated in the sealing slot 124. After that, the container 118 is placed into the sealing slot 124. Thus, the side frame 118b is combined to the surface of the substrate 112 in the bottom of the sealing slot 124 by using the sealing agent 122. Additionally, a desiccating agent or dry nitrogen gas can be filled into the closed room, which is formed while the container 118 and the substrate 112 are combined to each other, for preventing the organic light emitting display unit 114 from being damaged by the moisture in advance. According to the materials of the sealing agent, a proper curing process, such as a UV irradiation or a thermal curing process, can be performed to cure the sealing agent 122 and fix the container 118 onto the substrate 112. The fabricating process of the sealing structure is completed thereby.

In comparison with the prior art sealing structure of the organic light emitting display device, the sealing structure of the present invention has a sealing slot extended through to the substrate surface on the passivation layer. Therefore, the container can be combined to the substrate by using the sealing agent directly. Since the container and the substrate are made of the same material, the attachment between the sealing agent and the devices nearby can be improved effectively to prevent the moisture from penetrating the organic light emitting display unit beneath so as to improve the display performance and increase the lifetime of the display devices. In addition, comparing with the sealing structure in the prior art in which the sealing agent is exposed to the external atmosphere, the sealing agent in the present invention is coated in the bottom of the sealing slot and is not exposed to the external atmosphere. Thus, the possibility of moisture penetrating can be reduced so that the display performance can be improved and the lifetime of the display device can be lengthened in advance.

Those skilled in the art will readily observe that numerous modifications and alterations of the device may be made while retaining the teachings of the invention. Accordingly, the above disclosure should be construed as limited only by the metes and bounds of the appended claims.

1. A sealing structure disposed on an organic light emitting display panel, the display panel comprising a substrate and an organic light emitting display unit on the substrate, the sealing structure comprising:
a passivation layer covering the substrate and the organic light emitting display unit, the passivation layer comprising a sealing slot extending through to the surface of the substrate enclosing the organic light emitting display unit;
a container comprising a flat top plate and an extruded side frame surrounding the edge of the top plate, the shape of the side frame corresponding to that of the sealing slot; and
a sealing agent coated on the bottom of the sealing slot for combining the side frame of the container onto the substrate surface in the bottom of the sealing slot.

2. The sealing structure of claim 1 wherein the container is a glass container.

3. The sealing structure of claim 2 wherein the substrate is a glass substrate.

4. The sealing structure of claim 1 wherein the sealing agent comprises a curable material.

5. The sealing structure of claim 1 wherein the sealing agent comprises epoxy compounds.

6. The sealing structure of claim 1 wherein the passivation layer is a multi-layer stacked structure.

7. The sealing structure of claim 1 wherein the passivation layer comprises a silicon oxide material or a silicon nitride material.

8. A method of fabricating a sealing structure, the sealing structure disposed on an organic light emitting display panel, the organic light emitting display panel comprising a substrate and an organic light emitting display unit positioned on the substrate, the method comprising the following steps:
providing a container comprising a flat top plate and an extruded side frame surrounding the edge of the top plate;
forming at least a passivation layer covering the organic light emitting display unit and the substrate, the passivation layer comprising a sealing region defined on the surface of the passivation layer enclosing the organic light emitting display unit, the shape of the sealing region corresponding to that of the side frame;
removing the passivation layer in the sealing region to form a sealing slot through to the surface of the substrate; and
combining the side frame of the container to the surface of the substrate in the bottom of the sealing slot with a sealing agent.

9. The method of claim 8 wherein the container is a glass container.

10. The method of claim 8 wherein the substrate is a glass substrate.

11. The method of claim 8 wherein the sealing agent comprises a curable material.

12. The method of claim 8 wherein the sealing agent comprises epoxy compounds.

13. The method of claim 11 wherein the method further comprises a curing process to cure the sealing agent for combining the container onto the substrate.

14. The method of claim 8 wherein the passivation layer is a multi-layer stacked structure.

15. The method of claim 8 wherein the passivation layer comprises a silicon oxide material or a silicon nitride material.
